(19) United States
(12) Patent Application Publication
(10) Pub. No.: US 2013/0039839 A1
(43) Pub. Date: Feb. 14, 2013

(54) PRODUCTION OF CARBON NANOTUBES

(71) Applicants: Heiko Hocke, Leverkusen (DE); Ralph Weber, Leichlingen (DE); Oliver Felix-Karl Schlüter, Leverkusen (DE); Volker Michele, Koln (DE); Leslaw Mileczko, Dormagen (DE)

(72) Inventors: Heiko Hocke, Leverkusen (DE); Ralph Weber, Leichlingen (DE); Oliver Felix-Karl Schlüter, Leverkusen (DE); Volker Michele, Koln (DE); Leslaw Mileczko, Dormagen (DE)

(73) Assignee: Bayer Intellectual Property GmbH, Monheim (DE)

(21) Appl. No.: 13/579,007

(22) PCT Filed: Feb. 14, 2011
(86) PCT No.: PCT/EP2011/052086

§ 371 Date: Oct. 25, 2012

(30) Foreign Application Priority Data
Feb. 16, 2010 (DE) 10 2010 008 173.6

(51) Int. Cl. D01F 9/12; B01J 37/16; B01J 35/02; B82Y 40/00; B82Y 30/00

(52) U.S. Cl. 423/447.2; 502/300; 423/447.1; 977/742; 977/842

(57) ABSTRACT

The invention relates to a novel process for the production of catalysts for the production of carbon nanotubes in agglomerated form, which are characterised by a low bulk density. This invention likewise provides the catalysts, their use in the production of carbon nanotubes in high catalyst-specific yields, and the carbon nanotubes produced by this process.

The invention relates to a novel process for the production of catalysts for the production of carbon nanotubes in agglomerated form, which are characterised by a low bulk density. This invention likewise provides the catalysts, their use in the production of carbon nanotubes in high catalyst-specific yields, and the carbon nanotubes of low bulk density produced by this process.

According to the prior art, carbon nanotubes are mainly understood as being cylindrical carbon tubes having a diameter of from 3 to 100 nm and a length which is a multiple of the diameter. These tubes consist of one or more layers of ordered carbon atoms and have a core which differs in terms of morphology. Carbon nanotubes are also referred to as “carbon fibrils” or “hollow carbon fibres”, for example.

Carbon nanotubes have been known for a long time in the expert literature. Although Iijima (publication: S. Iijima, Nature 354, 56-58, 1991) is generally referred to as the discoverer of carbon nanotubes, these materials, in particular fibrous graphite materials having a plurality of graphite layers, have been known since the 1970s or early 1980s. Tates and Baker (GB 1469930A1, 1977 and EP 56004 A2) described for the first time the deposition of very fine fibrous carbon from the catalytic decomposition of hydrocarbons. However, the carbon filaments produced on the basis of short-chained hydrocarbons are not characterised in greater detail in respect of their diameter.

Conventional structures of these carbon nanotubes are those of the cylinder type. In the case of the cylindrical structures, a distinction is made between single-wall (mono)carbon nanotubes (SWCNTs) and multi-wall cylindrical carbon nanotubes (MWCNTs). Conventional processes for their production are, for example, arc discharge, laser ablation, chemical vapour deposition (CVD process) and catalytic chemical vapour deposition (CCVD process).

The formation of carbon tubes by the arc discharge process is known from Iijima, Nature 354, 1991, 56-8, which carbon tubes consist of two or more graphene layers and are rolled up to form a seamless closed cylinder and nested inside one another. Depending on the roll-up vector, chiral and achiral arrangements of the carbon atoms in relation to the longitudinal axis of the carbon fibres are possible.

There are additionally described carbon nanotubes which have a so-called herringbone morphology (J. W. Geus, EP application 198,558) and others which have a bamboo-like structure (Z. Ren, U.S. Pat. No. 6,911,260 B2).

Structures of carbon nanotubes in which a single cohesive graphene layer (so-called scroll type) or broken graphene layer (so-called onion type) is the basis for the structure of the nanotubes were described for the first time by Bacon et al., J. Appl. Phys. 34, 1960, 283-90. The structure is referred to as the scroll type. Later, corresponding structures were also found by Zhou et al., Science, 263, 1994, 1744-47 and by Lavin et al., Carbon 40, 2002, 1123-30.

A further type of scroll structures has recently been described in patent application WO 2009/036877 A2. These CNT structures consist of several graphene layers which are combined to form a stack and are rolled up (multi-scroll type). The individual graphene or graphite layers in these carbon nanotubes, when viewed in cross-section, run continuously from the centre of the CNTs to the outside edge without a break.

Within the scope of the invention, all the above-described structures of carbon nanotubes are combined in the following simply as carbon nanotubes or CNTs or MWCNTs (multi-wall CNTs).

The methods known today for the production of carbon nanotubes include arc discharge, laser ablation and catalytic processes. In many of these processes, carbon black, amorphous carbon and fibres having a large diameter are formed as by-products.

In the catalytic processes, a distinction can be made between deposition on, for example, supported catalyst particles and deposition on metal centres formed in situ having diameters in the nanometre range (so-called flow processes).

In the case of production via the catalytic deposition of carbon from hydrocarbons which are gaseous under reaction conditions (CCVD hereinbelow; catalytic chemical vapour deposition), acetylene, methane, ethane, ethylene, butane, butene, butadiene, benzene and further carbon-containing starting materials are mentioned as possible carbon donors. CNTs obtainable by catalytic processes are therefore preferably used.

The prior art in respect of catalytic processes for carbon nanotube production is summarised hereinbelow.

The catalysts generally contain metals, metal oxides or decomposable or reducible metal components. For example, Fe, Mo, Ni, V, Mn, Sn, Co, Cu and further subgroup elements are mentioned in the prior art as metals for the catalyst. Although most of the individual metals have a tendency to assist the formation of carbon nanotubes, high yields and low contents of amorphous carbons are advantageously achieved according to the prior art with metal catalysts that are based on a combination of the above-mentioned metals.

Heterogeneous metal catalysts can be produced in various ways. Mention may be made here, for example, of precipitation on support materials, the impregnation of support materials, co-precipitation of the catalytically active substances in the presence of a support, co-precipitation of the catalytically active metal compounds together with the support material, or co-precipitation of the catalytically active metal compounds together with an inert component.

As is apparent from WO 2006/050903 A2, the formation of carbon nanotubes and the properties of the tubes that are formed depend in a complex manner on the metal component or a combination of a plurality of metal components used as catalyst, on the catalyst support material optionally used and the interaction between the catalyst and the support, on the starting material gas and partial pressure, on an admixture of hydrogen or further gases, on the reaction temperature and on the residence time or the reactor used.

It is also apparent from the prior art that particularly advantageous catalyst systems for the production of CNTs are based on combinations of metals or metal compounds which comprise two or more elements from the group Fe, Co, Mn, Mo and Ni. Reference may likewise be made in this connection, for example, to WO 2006/050903 A2 and the literature cited therein.

There is known from that application a process for the production of carbon nanotubes, in particular those having a diameter of from 3 to 150 nm and an aspect ratio length to diameter (L:D)>100, by decomposition of hydrocarbons on a heterogeneous catalyst which comprises Mn, Co, preferably also molybdenum, as well as an inert material. Both supported and bulk catalysts are described, which can be produced by means of all the above-mentioned processes and can be used with or without pre-treatment. In the examples, the catalysts are calcined in air (i.e. oxidatively) at temperatures of from 400° C. to 450° C.

The production of carbon nanotubes having diameters less than 100 nm was described for the first time in EP 205 556 B1. For the production, light (i.e. short- and medium-chained aliphatic or mono- or di-nuclear aromatic) hydrocarbons and an iron-based catalyst are used, on which carbon carrier compounds are decomposed at a temperature above 800° C.-900° C.

WO 86/03455 A1 describes the production of carbon filaments which are said to have a cylindrical structure with a constant diameter of from 3.5 to 70 nm, an aspect ratio (length-to-diameter ratio) of greater than 100 and a core region. These fibrils consist of many continuous layers of ordered carbon atoms which are arranged concentrically around the cylindrical axis of the fibrils. As possible catalysts there are mentioned very generally “suitable metal-containing particles”, but the implementation examples mention only various iron catalysts which are obtained, for example, by impregnation of various aluminium oxides with iron salts in aqueous solution. Various methods of pre-treatment are described. The reductive calcination of an iron catalyst supported on aluminium oxide at temperatures up to 1100° C. in order to activate CNT growth from benzene is described. In the case of supported catalysts, however, a catalytically active spinel structure containing catalytically active metal constituents does not form during a calcination. Although the non-catalytically active support can be a layered structure (LDH=layered doubled hydroxide structure) or a spinel structure, this is not bonded to a catalytically active component (Fe, Co, Ni). This means that no M(II)/M(III) metal ions are exchanged for catalytically active Fe, Co or Ni ions in the support. In the case of supported catalysts, the catalytically active centres are present in clusters beside the non-active LDH or spinel structures. At most a small amount of Co (Fe, Ni) (<5%) is bonded with the Al (interface). High reduction temperatures, in particular in hydrogen, therefore accelerate only the sintering of the supported Co clusters (Fe, Ni clusters), which leads to thicker CNTs and further reduced activity, provided the Co cluster size (Fe, Ni) exceeds the maximum size suitable for CNT synthesis.

Thus, WO 86/003455 A1 discloses that the supported catalysts described therein are not active or are only slightly active despite hydrogen pre-treatment at 900° C. In supported catalysts, the decomposition of the catalyst particles by the epitaxial growth proceeds markedly differently from the epitaxial growth on bulk catalysts, so that the disclosure therein provides no teaching for the further optimisation of bulk catalysts.

Moy et al. (U.S. Pat. No. 7,198,772 B2 and U.S. Pat. No. 5,726,116 B2) report for the first time on different fibril agglomerate morphologies. They distinguish 3 different morphologies, the bird's nest structure (BN), the combed yarn structure (CY) and the open net structure (ON). In the bird's nest structure (BN), the fibrils are arranged randomly entangled in such a form that a ball of intertwined fibrils is formed, which is similar to the structure of a bird's nest. The yarn structure (CY=combed yarn) consists of bundles of carbon nanotubes which largely have the same relative orientation. The open net structure (ON) is formed by fibril agglomerates in which the fibrils are loosely interwoven. The agglomerates formed of CY and ON structures are said to be more readily dispersible than those of the BN structure, that is to say the individual CNTs can better be detached from the agglomerate and distributed. This is said to have advantages, for example, in the production of composite materials. The CY structure is said to be particularly preferred from this point of view.

Moy et al. likewise state that the macroscopic morphology of the aggregates is determined only by the choice of catalyst support material. In general, catalysts produced from spherical support materials subsequently yield fibril agglomerates with a bird's nest structure, while aggregates with CY or ON structures are only formed when the support material has one or more simply cleavable planar surfaces. Preference is given to support materials such as gamma-alumina or magnesia, which are composed of tabular, prism- or leaf-like crystals. Catalysts with iron as the active metal are mentioned by way of example, which catalysts form CY or ON agglomerate structures with aluminium oxide (H705® from ALCOA) or magnesium oxide from Martin Marietta Magnesia Specialties, LLC as support material on fibril synthesis. By contrast, the use of aluminium oxide Oxide C from Degussa as support material results in fibril agglomerates with a BN structure.

These described catalysts are produced by impregnation or precipitation of the active metal onto the solid support, that is to say the active metal is located on the surface of a given support material. Frequently, the support particle is at least partially still unchanged after the reaction.

Because of their high activity, however, bulk catalysts are of interest for carrying out CNT synthesis on a large scale. While in supported catalyst systems the active metal is located only on the surface of a (inert) support substance, in the co-precipitated spherical mixed oxides the catalytically active metal is homogeneously distributed throughout with the other metal oxides within the catalyst particle. The non-catalytically active metal oxides here act as binders and spacers. Ideally, this catalyst is broken open completely during the reaction and all the active metal centres are accessible for the reaction. The original catalyst particle is completely destroyed. Some of these mixed oxide catalysts have likewise been used for the synthesis of carbon nanotubes.

In the disclosures already mentioned above, Moy et al. likewise investigate co-precipitated catalysts based on iron, molybdenum and aluminium oxides for the synthesis of carbon nanotubes. Such mixed oxide catalysts are generally distinguished by increased efficiency as compared with supported catalysts, because the loading with active metal can be higher. In all cases, the CNT agglomerates synthesised from these mixed oxide catalysts had a bird's nest structure (BN).

In WO 2009/036877 A2, Meyer et al. disclose carbon nanotube powders containing carbon nanotubes which have a roll-like structure. In a preferred embodiment, the catalysts used therefor are produced by means of co-precipitation of the catalytically active metal compounds Co and Mn together with at least one further component. For conditioning of the catalyst, conditioning in an oxidative atmosphere is proposed both in the text and in the examples.

An as yet unanswered question from the prior art is how, when using co-precipitated catalysts, the agglomerate morphology can be adjusted in a simple manner. Furthermore, it is a common feature of the described processes from the described prior art for the production and treatment of co-precipitated catalysts that they yield catalysts which, owing to their high active content, yield CNT agglomerates with a high bulk density.

In DE 102009038464, which has not yet been published at the time of this application, a process for the production of agglomerate bundles of carbon nanotubes in the form of intertwined bunched-up yarns of carbon nanotubes and carbon nanotube agglomerates resulting therefrom are described. It is disclosed that the carbon nanotube agglomerates preferably have an bulk density according to EN ISO 60 of particularly preferably from 50 to 150 kg/m³. The synthesis is carried out on oxidatively calcined catalysts (examples), but the resulting yields are not yet satisfactory.

Because the yield A [in g (CNT)/g (cat)] and bulk density S (in g/l or kg/m³) of the CNTs are both properties of the catalyst, the ratio of yield to bulk density² is suitable as a parameter for describing the catalyst quality (O):

Q=A/S²*1000(g*l²/g³).

Because the quality of a catalyst for the production of carbon nanotubes can be described by high yield and as low a bulk density as possible, values of Q that are as high as possible are of interest.

The catalysts from the prior art yield CNTs having values for Q in the range from 2 to 3 g*l²/g³. The object of the present invention was to provide a process for the production of carbon nanotubes which uses co-precipitated catalysts which overcome the above-mentioned disadvantages of the prior art, in particular the high bulk density of the product which is frequently coupled with a high activity, that is to say a high yield.

The activity or the—(catalyst-)specific—yield A of a catalyst is defined within the scope of the present invention as A=mass CNT product (g)/dry mass catalyst (g).

Further objects of the invention which are to be achieved, such as, for example, the provision of a production process that is as economical as possible, will become apparent to the person skilled in the art from the further description.

It has now been found, surprisingly, that co-precipitated metal catalysts, the production process of which comprises a reduction step, and their use in the production of carbon nanotubes, are able to remedy the described deficiencies of the prior art.

Accordingly, the invention provides a process, comprising a reduction step, for the production of co-precipitated catalysts which can be used in the production of carbon nanotubes which are characterised in that they are obtained as agglomerates with low bulk densities, in a high yield and in high purity.

The invention also provides the co-precipitated catalysts produced by this process comprising a reduction step, and a process for the production of carbon nanotubes in which the catalysts according to the invention are used, as well as the carbon nanotubes which are produced by this CNT production process with low bulk densities, in high yields and in high purity.

The carbon nanotubes produced using the catalysts according to the invention have a bulk density of not more than 130 g/l, preferably less than 120 g/l and/or less than 110 g/l, particularly preferably less than 100 g/l and most particularly preferably less than 90 g/l. The minimum bulk density to be established is determined by technical factors and is approximately 20 g/l or 30 g/l. The bulk density is determined according to EN ISO 60.

The carbon nanotubes have a purity of >90 wt. %, preferably a purity of >95 wt. % and most particularly preferably of >97 wt. %.

In a preferred embodiment, it is possible with the aid of the treated catalysts to produce carbon nanotubes in a ratio of Q=yield/bulk density²*1000 of >3 g*l²/g³, particularly preferably of 3.5 g*l²/g³ and >4.5 g*l²/g³ and particularly preferably of >5 g*l²/g³ or of >6 g*l²/g³ and most particularly preferably of >7 g*l²/g³. In particular embodiments it is even possible to produce CNTs in a ratio Q>8, 9, 10, 11 or 12 g*l²/g³.

In a further preferred embodiment, the carbon nanotubes produced are predominantly multi-wall CNTs (MWCNTs) and/or multi-scroll CNTs.

The carbon nanotubes preferably have a diameter of from 3 to 100 nm and a length-to-diameter ratio of at least 5.

The catalysts used are produced by co-precipitation. Suitable starting products and processes are described, for example, in WO 2007/093337 A2 (pages 3-7) and in EP 181259 (p. 7/8).

A particularly preferred embodiment of the catalyst production is set out in the following description:

The metal precursors used for the co-precipitation are so selected that, in addition to layered structures (referred to hereinbelow as “LDH” as an abbreviation for “layered double hydroxides”), spinels in particular can form by calcination in the production by precipitation. LDH have the general structure [M(II)²⁺₍₁₋ₓ₎M(III)³⁺ₓ(OH)₂]^{x+}[A⁻_{x/m}]^{x-}.n(H₂O), wherein M=metal and A=anion, for example carbonate or nitrate, for pure phases 0.2≦x0.33, mixed, phases are also possible with 0.1≦x0.5; n is between 0.5 and 4, m is given by the charge of the anion, an example of a pure phase hydrotalcite=Mg₆Al₂(CO₃)(OH)₁₆.4H₂O. Here M(II)=Mg, M(III)=Al, x=0.25 and n=0.5, 8 formula units giving the mentioned structure. Spinets can be described by the composition M(H)M(II)₂O₄, wherein M(II) represents divalent metals and M(III) represents trivalent metals.

The precursors are present in a metal salt solution, from which the catalyst is precipitated. This solution contains in dissolved form at least one metal which catalyses the formation of carbon nanotubes. Suitable catalytically active metals are, for example, all transition metals. Examples of particularly suitable catalytically active metals are Fe, Ni, Cu, W, V, Cr, Sn, Co, Mn and Mo. Most particularly suitable catalytically active metals are Co, Mn and Mo. The metal salt solution further contains at least one further metal component, which either forms a support material in further steps of the catalyst treatment or forms a catalytically active mixed compound together with the transition metals.

Particularly suitable divalent metals are Mg(II), Mn(II), Co(II), Ni(II), Fe(H), Zn(H) and Cu(II). Examples of particularly suitable trivalent metals are Al(II), Mn(III), Ni(III), Fe(III), V(III), Cr(III), Mo(III) and rare earth metals.

Various starting compounds can be used, provided they are soluble in the solvent used, that is to say in the case of the co-precipitation can also be precipitated conjointly. Examples of such starting compounds are acetates, nitrates, chlorides and further soluble compounds.

Preferred solvents are short-chained (C1 to C6) alcohols, such as, for example, methanol, ethanol, n-propanol, isopropanol or butanol, and water, as well as mixtures thereof. Aqueous synthesis routes are particularly preferred.

The precipitation can be effected, for example, by a change in the temperature, the concentration (also by evaporating off the solvent), by a change in the pH value and/or by the addition of a precipitation agent, or combinations thereof.

Examples of suitable precipitation agents are solutions of ammonium carbonate, ammonium hydroxide, urea, alkali and alkaline earth carbonates and alkali and alkaline earth hydroxides in the above-mentioned solvents.

The precipitation can be carried out discontinuously or continuously. For continuous precipitation, the metal salt solution and optionally the precipitation reagent and further components are mixed by means of conveyor apparatuses in a mixing element with a high mixing intensity. Static mixers, Y-mixers, multi-lamination mixers, valve-assisted mixers, micromixers, (two-component) nozzle mixers and further similar mixers known to the person skilled in the art are preferred.

In order to improve the precipitation behaviour and for surface modification of the solids produced, surface-active substances (e.g. ionic or non-ionic surfactants or carboxylic acids) can be added.

It is advantageous, and therefore preferred, to co-precipitate the components forming the catalyst in particular from aqueous solution, for example with addition of ammonium carbonate, ammonium hydroxide, urea, alkali carbonates and hydroxides as precipitation reagent.

In one embodiment, the continuous co-precipitation of the catalytically active metal compounds is carried out together with at least one further component which, in further steps of the catalyst treatment, forms either a support material or a catalytically active mixed compound. There may be mentioned as examples of such further components Al, Mg, Si, Zr, Ti, etc. or conventional mixed metal oxide-forming elements known to the person skilled in the art. The content of the further components can be from 1 to 99 wt. %, based on the total mass of the catalyst. Preferably, the catalysts according to the invention have a content of further components of from 5 to 95 wt. %.

The catalyst obtained in the form of a solid can be separated from the starting material solutions by methods known to the person skilled in the art, such as, for example, filtration, centrifugation, concentration by evaporation and concentration. Centrifugation and filtration are preferred. The resulting solid can further be washed or can be used further directly, as obtained. In order to improve handling of the resulting catalyst, it can be dried.

A preferred transition metal combination is based on the components manganese and cobalt, optionally with the addition of molybdenum. In addition to these components, one or more metal components can be added. Examples thereof are all transition metals, preferably metal components based on the elements Fe, Ni, Cu, W, V, Cr, Sn.

The catalyst so obtained, which is as yet untreated, preferably contains from 2 to 98 mol % Mn and from 2 to 98 mol % Co, based on the content of active components in metal form. A content of from 10 to 90 mol % Mn and from 10 to 90 mol % Co is particularly preferred, and a content of from 25 to 75 mol % Mn and from 25 to 75 mol % Co is most particularly preferred. The sum of the contents of Mn and Co, or Mn, Co and Mo, is not necessarily 100 mol % if further elements as mentioned above are added. It is preferred to add from 0.2 to 50.0 mol % of one or more further metal components. For example, Mo can be added in the range from 0 to 10 mol % molybdenum.

Particular preference is given to catalysts which contain similar amounts by mass of Mn and Co. A Mn/Co ratio of from 2:1 to 1:2, particularly preferably from 1.5:1 to 1:1.5, is preferred.

Another preferred form of the catalyst contains preferably from 2 to 98 mol % Fe and from 2 to 98 mol % Mo, based on the content of active components in metal form. A content of from 5 to 90 mol % Fe and from 2 to 90 mol % Mo is particularly preferred, and a content of from 7 to 80 mol % Fe and from 2 to 75 mol % Mo is most particularly preferred. The sum of the contents of Fe and Mo is not necessarily 100 mol % if further elements as mentioned above are added. It is preferred to add from 0.2 to 50 mol % of one or more further metal components.

The mixed catalysts produced by the co-precipitation are reduced according to the invention (reduction step, reductive calcination).

The reduction (reductive calcination) takes place preferably in a temperature range from 200 to 1000° C., particularly preferably in a range from 400 to 900° C. and most particularly preferably in a range from 700 to 850° C. A further preferred temperature range for the reduction step is from 400 to 950° C., most particularly preferably from 680 to 900° C. and in particular a range from 700 to 880° C.

The reduction time is dependent on the chosen temperature range. A reduction time in a range of t=from 0.10 to 6.00 hours, in particular from 0.15 to 4.00 hours and most particularly from 0.20 to 2.00 hours, is preferred.

Hydrogen (H₂) is used as the reducing gas. It can be used in pure form (100 vol % H₂) or in admixture with inert gases, for example in a concentration range from 5 vol % to 50 vol % H₂, or >50 vol % H₂, particularly preferably >80 vol % H₂. Nitrogen or argon, for example, can be used as the inert gas, preferably nitrogen.

It is further possible to use as the reducing gas all compounds which are reducing but do not contain carbon and which are gaseous under reaction conditions. Examples which may be mentioned here are ammonia, hydrazines or boranes.

The reducing gas does not contain appreciable hydrocarbon constituents (<10 vol %, in particular <5 vol %).

The reduction can be carried out at pressures from 20 mbar to 40 bar, preferably from 1 to 20 bar, particularly preferably from 1 to 4 bar. A range from 100 mbar to normal pressure (about 1 atm or 1013 bar) is likewise preferred.

In a further embodiment of the reduction step, the catalyst is reduced by the waste gas from the CNT synthesis, optionally with heating to the desired temperature. This can take place either spatially separately, for example in a further reactor separate from the CNT synthesis, or in the reactor of the CNT synthesis.

In a possible embodiment, the co-precipitated mixed catalyst is oxidatively calcined before the reduction step. The calcination step effects the removal of the nitrate and the formation of the oxides and of a phase structure which is pressure- and temperature-dependent. Preferably, an oxidative calcination is carried out at temperatures from 200° C. to 1000° C., particularly preferably from 300° C. to 1000° C., at pressures from 20 mbar to 40 bar, at low pressure, at excess pressure or in particular at normal pressure. The oxidative calcination can be carried out in air (corresponding to approximately 20 vol % O₂ in N₂), in pure oxygen, in air diluted with inert gases or in dilute oxygen. Also possible are oxygen-containing compounds which are reducible under the corresponding conditions, such as, for example, nitric oxides, peroxides, halogen oxides, water and the like.

In another possible embodiment, the catalyst is calcined before the reduction step in inert gas (nitrogen, noble gases, CO₂, particularly preferably N₂ and argon, most particularly preferably N₂). Preferably, this calcination is carried out at temperatures from 200° C. to 1000° C., particularly preferably from 400° C. to 900° C., most particularly preferably from 700 to 850° C., and at pressures from 20 mbar to 40 bar, at low pressure, at excess pressure or in particular at normal pressure.

In a further possible embodiment, a combination of oxidative, inert and reductive calcination is carried out before the reduction step in order to reduce the sintering of cobalt and adjust the phase at higher temperatures. The conditions mentioned above for the individual steps can be established therefor.

In an exemplary embodiment, the catalyst is reduced at about 700° C. in H₂. This temperature is sufficient for a reduction of the cobalt oxide. The reduced catalyst is subsequently passivated and then maintained at higher temperatures (tempered), for example at about 850° C., in nitrogen. The passivation (coating of the elemental Co with a thin oxide layer) protects the Co from sintering during the subsequent tempering, because the oxide layer reduces the mobility of the Co particles. The tempering serves to improve the structuring of the inert component or to adjust a crystallite phase (for example conversion of gamma- to theta-aluminium).

In a further possible embodiment of the process according to the invention, the catalyst is again passivated with a thin oxide layer, for example with oxygen gas or an oxygen-containing gas or gas mixture, after the reduction step. This permits stable handling (transport, filling actions, etc.) in air, which it has been possible to demonstrate in long-term tests. This passivation is preferably effected by passing over a gas or gas mixture containing up to 5 vol % oxygen, preferably from 0.001 to 5.000 vol % oxygen, at room temperature for at least 10 minutes, for example approximately or at least 15 minutes, and then increasing the oxygen content in the gas mixture stepwise to 20 vol % oxygen. The time until the oxygen content is increased to 20 vol % can also be chosen to be longer, without thereby damaging the catalyst. Preferably, the temperature of the catalyst is monitored and heating by the resulting heat of hydrogenation is prevented by regulating the gas stream. The passivation can also be effected by means of oxygen-containing compounds that are reducible under the corresponding conditions, such as, for example, nitric oxides, peroxides, halogen oxides, water and the like. The passivation takes place at temperatures<100° C., preferably <50° C., particularly preferably <30° C. Particularly preferably, the passivation is carried out with air diluted in nitrogen.

The reduction step, the calcination and passivation steps advantageously take place in furnaces suitable therefor, for example tube or muffle furnaces, or in a reactor suitable therefor. The steps can also be carried out in fluidised bed and moving bed reactors, as well as rotary furnaces and in the synthesis reactor used for the production of the CNTs.

The catalysts according to the invention can advantageously be used in the production of carbon nanotubes.

The present invention further provides the production of carbon nanotubes using the catalyst according to the invention.

The production of carbon nanotubes can be carried out in various types of reactor. Examples which may be mentioned here are fixed bed reactors, tubular reactors, rotary tubular reactors, moving bed reactors, reactors with a bubble-forming, turbulent or irradiated fluidised bed, called internally or externally circulating fluidised beds. It is also possible to introduce the catalyst into a reactor filled with particles which falls, for example, under the above-mentioned classes. These particles can be inert particles and/or can consist wholly or partially of a further catalytically active material. These particles can also be agglomerates of carbon nanotubes. The process can be carried out continuously or discontinuously, for example, continuously or discontinuously referring both to the supply of the catalyst and to the discharge of the carbon nanotubes that are formed with the consumed catalyst.

There come into consideration as starting materials light hydrocarbons such as aliphatic compounds and olefins. However, it is also possible to use alcohols, carbon monoxides, in particular CO, aromatic compounds with and without heteroatoms, and functionalised hydrocarbons, such as, for example, aldehydes or ketones, as long as they are decomposed on the catalyst. Mixtures of the above-mentioned hydrocarbons can also be used. There are suitable in particular, for example, methane, ethane, propane, butane or higher aliphatic compounds, ethylene, propylene, butene, butadiene or higher olefins or aromatic hydrocarbons or carbon monoxides or alcohols or hydrocarbons with heteroatoms. Preference is given to the use of short- and medium-chained aliphatic or mono- or di-nuclear aromatic hydrocarbons as well as cyclic aliphatic compounds, which can also be substituted. Aliphatic compounds (CₓH₂ₓ₊₂) and olefins (CₓH_{y}) having a C number x of x=from 1 to 4 are particularly preferably used.

The starting material that delivers carbon can be supplied in gaseous form or can be vaporised in the reaction chamber or a suitable apparatus located upstream. Hydrogen or an inert gas, for example noble gases or nitrogen, can be added to the starting material gas. It is possible to carry out the process according to the invention for the production of carbon nanotubes with addition of an inert gas or of a mixture of several inert gases with and without hydrogen in any desired combination. Preferably, the reaction gas consists of carbon carrier, hydrogen and optionally an inert component for establishing advantageous reactant partial pressures. The addition of a component that is inert in the reaction as an internal standard for analysis of the starting material or product gas or as a detection aid in process monitoring is also conceivable.

The production can take place at pressures above and below atmospheric pressure. The process can be carried out at pressures from 0.05 bar to 200 bar; pressures from 0.1 to 100 bar are preferred, and pressures from 0.2 to 10 bar are particularly preferred. The temperature can be varied within a temperature range from 300° C. to 1600° C. However, it must be sufficiently high that the deposition of carbon by decomposition takes place sufficiently quickly and must not lead to marked self-pyrolysis of the hydrocarbon in the gas phase. This would result in a high content of amorphous carbon in the resulting material, which is not preferred. The advantageous temperature range is from 500° C. to 800° C. A decomposition temperature of from 550° C. to 750° C. is preferred.

The catalyst can be introduced into the reaction chamber batchwise or continuously.

In a particular embodiment of the carbon nanotube production process, the catalyst is used in a dilute procedure (low HC content) for the reaction of hydrocarbons (HC) to carbon nanotubes, which permits even lower bulk densities with otherwise equal reaction conditions.

In a preferred embodiment, a hydrocarbon content of from 30 to 90 vol % is used, preferably from 50 to 90 vol %.

Inert gases such as nitrogen, as well as gases such as carbon monoxide or hydrogen can be added as further gases.

It has now been found, surprisingly, that the catalysts according to the invention in the production of carbon nanotubes retain a high surface area even at high calcination temperatures and accordingly start to act quickly in the CNT reactor, that is to say do not have to pass through an activation phase.

With the aid of the reduction step it is further possible to reactivate catalysts which have been calcined and thereby inactivated by high temperatures in an oxidative atmosphere, that is to say catalyst which has been “overcalcined” can be reactivated again by the reduction.

By means of the described process, by suitably establishing the reduction step and the oxidative or inert calcination step, it is possible to produce catalysts for CNTs having an adjustable thickness. This allows the so-called percolation curve of composites containing CNTs to be shifted along the wt. % axis and thus the conductivity of the composite to be established substantially more accurately, in particular in the region of the percolation threshold, than would be possible solely by means of the mass content of the CNTs. The percolation curve corresponds to the curve which is obtained when the specific resistance of a composite is plotted as a function of the degree of filling of the matrix (for example a polymer) with CNTs. In general, the resistance is initially very high in the case of non-conductive matrices. As the degree of filling increases, conductive paths of CNTs increasingly form in the composite. As soon as a continuous conductive path has formed, the resistance falls rapidly (percolation threshold). Once the percolation threshold has been reached, the resistance falls only very slowly even with a greatly increasing degree of filling. In an exemplary embodiment, it is possible by means of purposive oxidative pre-treatment, in particular by means of high oxidative pre-treatment temperatures, and subsequent (re-)activation by reductive calcination, purposively to increase the CNT diameters. The CNTs having a larger diameter effect a shift of the percolation threshold towards higher CNT amounts by mass in the composite. The effect can therefore be used to establish this threshold exactly.

In a further exemplary embodiment it has been found that the thickness of the CNTs resulting from the CNT production increases with a Co-containing catalyst according to the invention as the reductive calcination temperature increases (possibly as a result of sintering of the cobalt that forms). Accordingly, the thickness of the CNTs can be adjusted in the range of approximately from 10 to 50 nm, in particular from 10 to 40 nm and especially from 10 to 30 nm and 11 to 20 nm, in another embodiment in a range from 16 to 50 nm, and accordingly the percolation curve of a CNT/polymer composite can likewise purposively be shifted, for example, to higher CNT contents. The breadth of the diameter distribution of the CNTs can likewise be purposively adjusted.

If a higher treatment temperature or a longer treatment time (tempering) is required for the purposive adjustment of a crystalline phase, for example for the conversion of gamma-alumina phases into theta-alumina phases, this treatment at higher temperatures is preferably to be carried out under inert conditions if a simultaneous influence on the thickness of the CNTs is not desired.

It has been found that, in one embodiment, a reductive calcination at about 700° C. is already sufficiently quick to reduce the active component in a short time.

It is additionally advantageous that the process according to the invention is carried out in the last sub-step of the catalyst production. As a result it is possible, while using the same catalyst precursor, purposively to obtain different product qualities with otherwise identical CNT production process conditions by means of different embodiments of the reduction step. At reduction temperatures>=800° C., for example, there are preferably formed with the catalysts described here yarn-like structures in which the individual CNTs, for example, within macroscopic domains have the same preferential orientation, in the manner of grass, or occur within braids comprising up to several hundred individual CNTs without a preferred orientation relative to one another. At temperatures in the reduction step of <800° C., agglomerates having a so-called BN structure are preferably formed. The carbon nanotubes can also have mixed structures. They have a structure which is different from the structure they will acquire with the non-reduced catalyst.

By means of the invention it is possible for the first time to produce CNT agglomerates with a low bulk density and in a high yield (based on catalyst) and at the same time with high catalyst-specific activity.

An advantage of the CNT agglomerates with a low bulk density is the improved dispersibility of the CNT agglomerates, which manifests itself, for example, by simplified intrusion of a polymer melt and, associated therewith, better wetting of the CNTs. Improved dispersibility generally improves the mechanical, haptic and optical properties of CNT composite materials (polymers, coatings and metals) because non-dispersed agglomerate residues both represent predetermined breaking points under mechanical load and cause a matt and scarred composite surface. Inter alia, the CNT agglomerates with low bulk density so produced can more readily be incorporated into thermoplastic polymers, duroplastic polymers, rubbers, coatings, low- and medium-viscosity media such as water, solvents, oils, resins, as well as into metals. In thin-layer applications, finely divided CNTs are absolutely essential for producing the thin layer and for transparency, if desired. In addition, the better dispersing properties of the loose CNT agglomerates result in a reduced incorporation time and a reduction in the dispersing energy and forces, for example shear forces. This allows such a material to be processed into matrices that are unstable towards normal processing conditions.

Good dispersion of the CNTs or their agglomerates, with a simultaneously high CNT yield, permits low catalyst residual contents (<10 wt. %, in particular <5 wt. % and most particularly <3 wt. %) in the CNT product. This is advantageous for many areas of use, for example suppression of undesirable chemical reactions in various applications by the catalyst residues, such as polymer degradation or decomposition, radical reactions in epoxides and polymers, acid/base reactions, etc. A reduction in the content of catalyst metals in the product is also desirable because of the frequent toxic nature of the catalyst metals that are used. The high activity of the catalysts produced according to the invention additionally improves the space-time yield of the CNT production system and accordingly the economy of the process.

The process according to the invention yields catalysts which are suitable in particular for the production of CNT agglomerates with low bulk density (<90 g/l) and good pourability (flow index>20 ml/s, measured with the pourability tester from Karg-Industrietechnik (Code No. 1012.000) model PM and a 15 mm nozzle according to standard ISO 6186) in high yield (>20 g/g, preferably >30 g/g and most particularly preferably >40 g/g) and high purity.

In most cases, the carbon nanotubes so produced, because of the low catalyst content, can be used in the end product without previously being worked up. The materials can optionally be purified, for example by chemical dissolution of the catalyst and support residues, by oxidation of the amorphous carbon components that are formed in very small amounts, or by thermal after-treatment in an inert or reactive gas. It is possible to chemically functionalise the carbon nanotubes that are produced in order, for example, to obtain better bonding in a matrix or purposively to adapt the surface properties to the desired application.

The carbon nanotubes produced according to the invention are suitable for use as additives in polymers, in particular for mechanical strengthening and for increasing the electrical conductivity. The carbon nanotubes that are produced can further be used as a material for gas and energy storage, for colouring and as a flame retardant. On account of their good electrical conductivity, the carbon nanotubes produced according to the invention can be used as an electrode material or to produce strip conductors and conductive structures. It is also possible to use the carbon nanotubes produced according to the invention as emitters in displays. Preferably, the carbon nanotubes are used in polymer composite materials, ceramics or metal composite materials for improving the electrical or thermal conductivity and mechanical properties, for the production of conductive coatings and composite materials, as a colouring, in batteries, sensors, capacitors, displays (e.g. flat screen displays) or illuminants, as a field effect transistor, as a storage medium, for example for hydrogen or lithium, in membranes, for example for the purification of gases, as a catalyst or as a support material, for example for catalytically active components in chemical reactions, in fuel cells, in the medical field, for example as a structure for controlling the growth of cell tissue, in the diagnostic field, for example as a marker, and in chemical and physical analysis (e.g. in scanning force microscopes).

The process according to the invention, the catalysts and uses according to the invention are illustrated hereinbelow with reference to some examples; the examples are not, however, to be understood as a limitation of the inventive idea.

### EXAMPLES

### Example 1

### Production of a Catalyst (Comparison)

### a) Precipitation, Drying and Milling

A solution of 0.306 kg of Mg(NO₃)₂.6H₂O in water (0.35 litre) was mixed with a solution of 0.36 kg of Al(NO₃)₃.9H₂O in 0.35 litre of water. Then 0.17 kg of Mn(NO₃)₂.4H₂O and 0.194 kg of Co(NO₃)₂.6H₂O, each dissolved in 0.5 litre of water, were added and the entire mixture, while being stirred for 30 minutes, was adjusted to a pH value of about 2 by addition of nitric acid. A stream of this solution was mixed in a mixer with 20.6 wt. % sodium hydroxide solution in a ratio of 1.9:1, and the resulting suspension was added to an initial charge of 5 litres of water. The pH value of the initial charge was maintained at about 10 by controlling the sodium hydroxide addition.

The resulting solid was separated from the suspension and washed several times. The washed solid was then dried within a period of 16 hours in a paddle dryer, the temperature of the dryer being increased within the first eight hours from room temperature to 160° C. Then the solid was milled in a laboratory mill to a mean particle size of 50 μm and the middle fraction in the range from 30 μm to 100 μm particle size was removed in order to facilitate the subsequent calcination, especially to improve fluidisation in the fluidised layer and to achieve a high yield of product.

### b) Oxidative Calcination

The solid was then calcined for 12 hours in a furnace at 500° C., with the admission of air, and then cooled for 24 hours. The catalyst material was then left to stand for 7 days at room temperature for post-oxidation. A total of 121.3 g of catalyst material was isolated.

### Example 2

### Production of Carbon Nanotubes (Comparison)

The catalyst produced in Example 1 was tested in a fluidised bed apparatus on a laboratory scale. To this end, a defined amount of catalyst was placed in a steel reactor having an inside diameter of 100 mm, which was heated from outside by means of a heat transfer medium. The temperature of the fluidised bed was regulated by PID control of the electrically heated heat transfer medium. The temperature of the fluidised bed was determined by a thermal element. Starting material gases and inert diluent gases were introduced into the reactor via electronically controlled mass flow regulators.

An initial CNT bed charge having an unexpanded height of about 30 cm was first introduced into the reactor in order to ensure thorough mixing. The reactor was then rendered inert with nitrogen and heated to a temperature of 650° C. An amount of 24 g of catalyst 1 according to Example 1 was then metered in.

Immediately thereafter, the starting material gas as a mixture of ethene and nitrogen was switched on. The volume ratio of the starting material gas mixture was ethene:N₂=90:10. The total volume flow was adjusted to 40 NL·min⁻¹. Exposure of the catalyst to the starting material gases was carried out for a period of 33 minutes. Thereafter, the continuing reaction was stopped by interrupting the supply of starting material, and the contents of the reactor were removed.

The amount of carbon deposited was determined by weighing, and the structure and morphology of the deposited carbon were determined by means of REM and TEM analyses. The amount of deposited carbon, based on catalyst used, referred to hereinbelow as the yield, was defined on the basis of the mass of catalyst after calcination (mcat,0) and the increase in weight after reaction (mtotal−mcat,0): Yield=(mtotal−mcat,0)/mcat,0.

The evaluation showed a catalyst yield, averaged over 5 test runs, of 35.3 g of carbon nanotube powder per g of catalyst used. The TEM photographs showed structures of about 2 to 3 rolled-up graphite layers each consisting of from 8 to 12 graphene layers. The carbon fibres had a mean diameter of 16 nm. The length-to-diameter ratio was at least 100.

Testing of the purity by determining the ignition loss gave a content of 96.9 wt. % carbon.

NO pyrolytically deposited carbon was detectable in the carbon nanotube powders in the TEM photographs.

The carbon nanotube powder had a surface area, measured according to BET, of 260 m²/g.

The bulk density of the agglomerate, averaged over 5 test runs, was 152 g/1.

### Example 3

### Production of an Uncalcined Catalyst (Comparison)

The catalyst was precipitated, separated off, washed, dried and milled as described in Comparison Example 1, step a). Step b) from Example 1, the oxidative calcination, was not carried out.

### Example 4

### Oxidative Calcination of a Catalyst (Comparison)

The uncalcined, dried catalyst from Example 3 was oxidatively calcined in a muffle furnace in air under the conditions indicated below.

Example 4a) Calcination in air for 6 hours at 400° C. at a pressure of 1 atm.

Example 4b) Calcination in air for 2 hours at 900° C. at a pressure of 1 atm.

### Example 5

### Production of a Catalyst According to the Invention by Reductive Calcination

The uncalcined, dried catalyst from Example 3 was reductively calcined in a tube furnace in a hydrogen/nitrogen mixture under the conditions indicated below and, after cooling to room temperature, was used directly in the CNT synthesis.

Example 5a) Reducing gas 5 vol % H₂ in N₂; reduction temperature=700° C., pressure=1 atm; t=0.5 h

Example 5b) Reducing gas 5 vol % H₂ in N₂; reduction temperature=800° C., pressure=1 atm; t=0.5 h

Example 5c) Reducing gas 5 vol % H₂ in N₂; reduction temperature=825° C., pressure=1 atm; t=0.5 h

Example 5d) Reducing gas 5 vol % H₂ in N₂; reduction temperature=825° C., pressure=1 atm; t=2.0 h

Example 5e) Reducing gas 100 vol % H₂; reduction temperature=700° C., t=1.0 h; pressure=40 mbar

### Example 6

### Production of a Catalyst According to the Invention by Reductive Calcination Preceded by Oxidative Calcination

The catalyst from Example 4 calcined in air was reductively calcined in a tube furnace in a hydrogen/nitrogen mixture or in pure hydrogen under the conditions indicated below and, after cooling to room temperature, was used directly in the CNT synthesis.

Example 6a) Reducing gas 5 vol % H₂ in N₂; reduction temperature=850° C., pressure=1 atm; t=30 min

Example 6b) Reducing gas 50 vol % H₂ in N₂; reduction temperature=850° C., pressure=1 atm; t=30 min

Example 6c) Reducing gas 100 vol % H₂; reduction temperature=850° C., pressure=1 atm; t=30 min

Example 6d) Reducing gas 100 vol % H₂; reduction temperature=900° C., pressure=1 atm; t=30 min

Example 6e) Reducing gas 100 vol % H₂; reduction temperature=950° C., pressure=1 atm; t=30 min

### Example 7

### Production of a Catalyst According to the Invention by Inert Calcination Preceded by Reductive Calcination

The uncalcined dried catalyst from Example 3 was subjected to the following calcination series in a tube furnace: i) reductive calcination in H₂ at 700° C. for 1 hour, ii) inert calcination in N₂ at 850° C. for 2 hours and, after cooling to room temperature, was used directly in the CNT synthesis.

### Example 8

### Production of a Catalyst According to the Invention by Inert Calcination Preceded by Oxidative Calcination

The catalyst from Example 4 calcined in air was subjected to the calcination series indicated below, in each case in a tube furnace, and, after cooling to room temperature, was used directly in the CNT synthesis.

Example 8a) i) Oxidative calcination with air at 400° C. for 6 h, ii) inert calcination in N₂ at 850° C. for 2 h

Example 8b) i) Oxidative calcination with air at 400° C. for 6 h, ii) reductive calcination in H₂ at 700° C. for 1 h, iii) inert calcination in N₂ at 850° C. for 2 h.

### Example 9

### Passivation of a Reductively Calcined Catalyst According to the Invention

The reduced catalyst from Example 6a) was passivated on the surface by treatment with air. To this end, the reduced catalyst was exposed at temperatures of about 40° C. for a period of t=15 minutes to a gas mixture whose O₂ content was gradually increased from 1 vol % O₂ in inert gas (N₂) to 20 vol % O₂ in inert gas.

The passive layer was removed again in the subsequent CNT synthesis in the CNT synthesis reactor at a temperature of 700° C. (time: 15 minutes).

### Example 10

### Re-Activation of an “Overcalcined” Catalyst

The catalyst from Example 4b calcined in air at 900° C. was reductively calcined in a H₂/N₂ mixture with 5 vol % H₂ at 825° C. for 2 hours and, after cooling to room temperature, was used directly in the CNT synthesis.

### Example 11

### Production of Carbon Nanotubes Using the Catalysts According to the Invention

The catalysts indicated above were used analogously to Example 2 in a fluidised bed for the production of carbon nanotubes. To this end, a defined amount of catalyst (dry mass=0.5 g, dry mass is the mass that the catalyst still possesses after calcination in air at 650° C. for 6 hours after loss of precursor residues and water) is placed in a quartz glass reactor having an inside diameter of 50 mm, which is heated from the outside by a heat transfer medium. The temperature of the fluidised bed was regulated by ND control of the electrically heated heat transfer medium. The temperature of the fluidised bed was determined by a thermal element. Starting material gases and inert diluent gases were passed into the reactor via electronically controlled mass flow regulators.

The reactor was then rendered inert with nitrogen and heated to a temperature of 700° C. within a period of 15 minutes.

Immediately thereafter, the starting material gas as a mixture of ethene and nitrogen was switched on. The volume ratio of the starting material gas mixture was ethene:N₂=90:10. The total volume flow was adjusted to 10 NL·min⁻¹. Exposure of the catalyst to the starting material gases was carried out for a period of 34 minutes as standard. Thereafter, the continuing reaction was stopped by interrupting the supply of starting material, and the contents of the reactor were cooled in N₂ within a period of 30 minutes and removed.

The amount of carbon deposited was determined by weighing, The amount of deposited carbon, based on catalyst used, referred to hereinbelow as the yield, was defined on the basis of the dry mass of catalyst (m_{cat.,dry}) and the increase in weight after reaction (mₜₒₜₐₗ−m_{cat.,dry}): Yield=(mₜₒₜₐₗ−m_{cat.,dry})/m_{cat.,dry}.

The resulting yields (A) and bulk densities (S) are listed in Table 1 together with the Q values calculated therefrom. Deviations from the above-mentioned reaction conditions are to be found in the last three columns.

A portion of the samples was studied using a transmission electron microscope (TEM) and the diameter of >200 individual tubes was measured. The mean values and standard deviation of the distribution found are likewise listed in Table 1. The standard deviation gives the distribution breadth and is not a measure of error of the determination (<0.5 nm).

Because the TEM photographs did not show deposits of amorphous carbon in any case, the purity of the samples is given by the yield to purity=yield/(yield+1). It follows that a purity of >90 wt. % is achieved at yields>8.9 g/g, purities of >95 wt. % at yields>18.8 g/g and purities>97 wt. % at yields>31.4 g/g.

TABLE 1

| | | | A | | | d [nm] | | |
|---|---|---|---|---|---|---|---|---|
| | Cat. from | Q = A/S²*1000 | [g(CNT)/ | S | Test time | (mean CNT | N₂ | Ethene |
| Example | example | [g*l²/g³] | g(dry cat.)] | [g/l] | (min) | diameter) | [NL*min⁻¹] | [NL*min⁻¹] |
| 2 | 1 | 1.5 | 35.3 | 152.0 | 33 | 16 | 4.0 | 36 |
| 11a | 4 | 2.5 | 50.0 | 142 | 34 | | 1 | 9 |
| 11b | 5a | 3.4 | 23.8 | 83.7 | 34 | 10.7 ± 4.0 | 1 | 9 |
| 11c | 5b | 6.0 | 60.4 | 100.2 | 34 | 11.5 ± 4.2 | 1 | 9 |
| 11d | 5c | 5.5 | 62.1 | 106.6 | 34 | 12.0 ± 3.8 | 1 | 9 |
| 11e | 5d | 6.3 | 69.3 | 105 | 34 | 11.0 ± 4.3 | 1 | 9 |
| 11f | 5e | 6.2 | 81.0 | 114 | 34 | | 1 | 9 |
| 11g | 6a | 6.3 | 68.0 | 104.2 | 34 | 16.1 ± 8.1 | 0.93 | 8.4 |
| 11h | 6b | 5.9 | 82.4 | 118 | 34 | 14.4 ± 6.8 | 0.93 | 8.4 |
| 11i | 6c | 4.7 | 99.4 | 146 | 34 | 11.9 ± 6.6 | 1 | 9 |
| 11j | 6c | 6.9 | 45.6 | 81.4 | 10 | 14.4 ± 6.2 | 1 | 9 |
| 11k | 9a | 6.4 | 41.7 | 80.5 | 34 | | 1 | 9 |
| 11l | 9b | 7.5 | 46.1 | 78.5 | 34 | | 1 | 9 |
| 11m | 9c | 6.4 | 41.3 | 80 | 34 | | 1 | 9 |
| 11n-1 | 4b | N/A | 0.0 | N/A | 34 | | 1 | 9 |
| 11n-2 | 10 | 6.4 | 29.8 | 68.04 | 34 | 19.4 ± 8.9 | 1 | 9 |
| 11o | 8a | 0.5 | 4.8 | 102 | 34 | | 1 | 9 |
| 11p | 8b | 12.0 | 49.2 | 64 | 34 | | 7 | 3 |
| 11q | 7 | 10.3 | 43.7 | 65 | 34 | | 1 | 9 |
| 11r | 7 | 17.3 | 36.7 | 46 | 26 | | 7 | 3 |

Examples 11b to 11e show that, by the reductive calcination of dried catalyst, increasingly better Q values are achieved as the treatment temperature and treatment time increase, which values are additionally significantly superior to the prior art (Example 2, 11a).

Even a reduction step carried out under reduced pressure leads to a positive result (Example 11f).

Examples 11 g to 11i (combination of oxidatively pre-treated catalysts with a reductive calcination under increasing H₂ partial pressure (5, 50 and 100 vol % H₂ at 1 bar) show that, even in samples calcined moderately (400° C.) in air, a significant improvement occurs as a result of the reductive calcination.

The yield of catalysts pre-treated in this manner increases considerably with the H₂ partial pressure. Although the bulk density likewise increases, the Q values are nevertheless markedly above 4 even at a H₂ partial pressure of 100 vol %.

The short-term test 11j (10 minutes) shows a high Q value of 6.9. With a yield that is comparable with or better than that of Comparison Examples 2 and 11a)—despite the shorter reaction time—the bulk density of the resulting carbon nanotubes product from Example 11j) is only about 60% of the bulk density of the CNTs of Examples 2 and 11a).

In addition, the mean diameters of the carbon nanotubes produced in tests 11 g to 11i) were determined by measuring >200 individual CNTs on transmission electron microscopy (TEM) photographs. As is clear from Table 1, the diameter becomes smaller as the partial pressure increases. As is known to the person skilled in the art, a greater aspect ratio (=length to diameter) is accordingly obtained with a constant length, as a result of which a lower CNT addition is required in composites to achieve the percolation threshold. The breadth of the diameter distribution is also reduced as the H₂ partial pressure increases, which is advantageous for the product quality.

Examples 11k) to 11m) show that the catalyst is effectively protected by passivation. Example 11k shows the result for passivated catalyst which was used immediately after passivation; Example 11l) shows results for the same catalyst after 1 week's storage in air, Example 11m after 8 weeks' storage in air. There are no significant differences. Temperatures of only 300 to 400° C. are sufficient to remove the passive layer.

Example 11n-1) shows the result of the carbon nanotube production using a catalyst calcined at 900° C. in air. This was inactive within the reaction time, so that no yield and bulk density could be determined. It was possible to activate the catalyst again by reductive calcination of the catalyst (Example 11n-2).

It was found that the diameter of the carbon nanotubes produced in Example 11n-2) is greatly increased (19±9 nm).

By purposive oxidative pre-treatment, for example by the high oxidative pre-treatment temperature set here and subsequent (re-)activation by reductive calcination, a purposive adjustment of the CNT diameters could accordingly be achieved. The yield was not significantly impaired as compared with a catalyst from the prior art (Example 2). The CNTs having a larger diameter effect a shift of the percolation threshold to higher CNT mass contents in the composite. The effect can therefore be used to adjust this threshold precisely.

Examples 110) to 11r) show results for the purposive after-treatment in an inert atmosphere.

Example 11o) shows that both the yield and the Q value are far below the values of the comparison examples in the case of an inert calcination without preceding reductive calcination.

If a reduction step is introduced before the inert calcination [Examples 11p) to 11r)], then the yields in the CNT synthesis increase considerably without the bulk density becoming too high. These tests yielded CNTs having high Q values>10. Even a shortened procedure (26 minutes) and a reduced ethene partial pressure have a positive influence on the Q value (Example 11r). As compared with Comparison Example 2, ⅓ of the bulk density can be achieved with the same yield—the Q value is improved more than 10-fold.

### Testing of the Carbon Nanotubes

All the percentages indicated in Examples 12 to 14 are percentages by weight, based on the total weight of the composite.

### Examples 12 and 13 (Incorporation into POM)

Example 12 (comparison): The CNTs produced under standard conditions (Example 11) using the catalyst from Example 4 were introduced by means of hopper feeding into a twin-screw extruder from Coperion/Werner & Pfleiderer (ZSK MC 26, L/D 36) and incorporated in an amount of 3 wt. % into polyoxymethylene (POM, Hostaform® C13031 from Ticona). The composite was then injection moulded to standard test specimens on an Arburg 370 S 800-150 injection moulding machine. The throughput was 15 kg/h and the melt temperature was 200° C. at 300 rpm.

Example 13): The CNTs (with Q=7 g*l²/g³) produced under standard conditions (Example 11) and with a test time of t=20 minutes using the catalyst from Example 6c were introduced by means of hopper feeding into a twin-screw extruder from Coperion/Werner & Pfleiderer (ZSK MC 26, L/D 36) and incorporated in an amount of 3 wt. % into polyoxymethylene (POM, Hostaform® C13031 from Ticona). The composite was then injection moulded to standard test specimens on an Arburg 370 S 800-150 injection moulding machine. The throughput was 15 kg/h and the melt temperature was 200° C. at 300 rpm.

The following CNT/POM composites were obtained:

| | Example 12) | Example 13) |
|---|---|---|
| Modulus of elasticity [MPa] (ISO 527) | 3526 | 3596 |
| Tension @ break [MPa] (ISO 527) | 69.8 | 72.9 |
| Elongation @ break [%] (ISO 527) | 4.8 | 10.7 |
| Izod impact [J/m] 23° C. (ASTM D256A, | 70 | 103 |
| 3.2 mm) | | |

### Example 14 (Incorporation into Polycarbonate)

The CNTs (with Q=7 g*l²/g³) produced under standard conditions (Example 11) and with a test time of t=20 minutes using the catalyst from Example 6c were introduced by means of hopper feeding into a twin-screw extruder from Coperion/Werner & Pfleiderer (ZSK M 25, L/D 36) and incorporated in an amount of 3 wt. % and 5 wt. % into polycarbonate (PC, Makrolon® 2800 from Bayer MaterialScience). The throughput was 20 kg/h and the melt temperature was 280° C. at 600 rpm. The composite was then injection moulded to circular disks (80 mm×2 mm). The conditions were 340° C. melt temperature, 90° C. tool temperature and 10 mm/s feed. The composite was then injection moulded to circular sheets having a diameter of 80 mm and a thickness of 2 mm on an Arburg 370 S 800-150 injection moulding machine. The sprue was located laterally. The injection moulding conditions were tool temperature 90° C., melt temperature 340° C. and feed 10 mm/s. The surface resistance was then measured using an annular electrode (Monroe model 272, 100 V). The sample with 3 wt. % CNTs had a surface resistance of about 10¹⁰ Ohm/sq, the sample with 5 wt. % a surface resistance of <10⁶ Ohm/sq.

Composites with CNTs (Q=9 g*l²/g³) produced under standard conditions (Example 11) and with a test time of t=20 minutes using catalysts 6d) were processed and measured analogously. For these composites, a surface resistance of about 10¹² Ohm/sq was found at a concentration of 3 wt. % CNTs and a surface resistance of 10⁷ to 10⁸ Ohm/sq for 5 wt. %.

1-12. (canceled)

13. A process producing a co-precipitated metal catalyst for the production of carbon nanotubes, comprising the step of reducing a catalyst to produce the co-precipitated metal catalyst for the production of carbon nanotubes.

14. The process according to claim 13, wherein the reduction step is carried out in a temperature range from 200 to 1000° C.

15. The process according to claim 13, wherein the reduction step is carried out in a temperature range from 400 to 950° C.

16. The process according to claim 13, wherein the reduction step is carried out in a temperature range from 680 to 900° C.

17. The process according to claim 13, wherein the reduction step is carried out in a temperature range from 700 to 880° C.

18. The process according to claim 13, wherein the reduction is carried out with a reducing gas which contains less than 10 vol % carbon-containing compounds.

19. The process according to claim 13, further comprising one or more process steps selected from the group consisting of oxidative calcination and inert calcination.

20. The process according to claim 13, wherein the metal catalyst yields carbon nanotubes in agglomerates having a bulk density of not more than 130 g/l, in a yield of at least 20 g/g and in a purity of at least 90 wt. %.

21. The metal catalyst produced by a process according to claim 13.

22. A metal catalyst for producing of carbon nanotubes having a ratio of Q=yield/bulk density²*1000 of >3 gl2/g3.

23. The metal catalyst of claim 22, wherein Q>3.5 gl2/g3.

24. The metal catalyst of claim 22, wherein Q>4.5 gl2/g3.

25. The metal catalyst of claim 22, wherein Q>5gl2/g3.

26. The metal catalyst of claim 22, wherein Q>6gl2/g3.

27. The metal catalyst of claim 22, wherein Q>7gl2/g3.

28. A process for production of a carbon nanotube comprising utilizing the metal catalyst produced by the process of claim 13.

29. The process according to claim 28, wherein the ratio Q=yield/bulk density*1000 is >3gl2/g3.

30. Carbon nanotubes having a bulk density of 130 g/l and a purity of at least 90 wt. %, obtained by the process according to claim 28.

31. A process comprising utilizing the carbon nanotubes according to claim 30 in the production of composites or dispersions.

32. A composite comprising the carbon nanotubes according to claim 30.
